(19) United States
(12) Patent Application Publication
(10) Pub. No.: US 2009/0253284 A1
(43) Pub. Date: Oct. 8, 2009

(54) ELECTRICAL CONNECTOR AND METHOD OF MANUFACTURING

(76) Inventors: Jean-Francois Michel, Yermenonville (FR); Ould Yahya, Leves (FR); Christian Campfort, Fresnay le Gilmert (FR)

Correspondence Address: HARRINGTON & SMITH, PC, 4 RESEARCH DRIVE, Suite 202, SHELTON, CT, 06484-6212, US

(21) Appl. No.: 12/309,750

(22) PCT Filed: Jul. 27, 2007
(86) PCT No.: PCT/EP2007/006667

§ 371 Date: May 5, 2009

(30) Foreign Application Priority Data
Jul. 27, 2006 (IB) PCT/IB2006/054098

(51) Int. Cl. H01R 13/52; H01R 43/16

(52) U.S. Cl. 439/283; 29/874

(57) ABSTRACT

An electrical connector includes a sealing joint having a passageway for receiving an electrical connection member, the passageway having a retention region including a first lip a second lip, and an inter-lip gap between said lips, each of said lip including an internal face, an external face opposite said internal face and a top face having an internal diameter Dᵢ.

### FIELD OF THE INVENTION

The present invention relates to electrical connectors and to methods of manufacturing electrical connectors.

### BACKGROUND OF THE INVENTION

In automotive applications, electrical connectors comprising a sealing joint are used. An electrical connection member is inserted through the sealing joint, and comprises a front portion metallic contact portion for connecting to a mating electrical connector or circuit, and a cable connecting part opposite to the front portion.

Such electrical connectors are submitted to extensive testing to make sure that, during assembly, upon insertion of the connection member through the joint, the mechanical integrity of the latter would not be impaired, which would be detrimental to the sealing ability of the whole seal. Similar tests occur to evaluate the ability of the joint to withstand extraction of the connection member from the sealing joint, for example for replacement of the electrical connection member.

Of course, the primary feature of interest for such a seal is its sealing ability, towards dust-carrying air or water. Sealing tests are for example performed during 30 seconds in a pressurized atmosphere of 0.5 bar, or a depressurized atmosphere of 0.5 bar.

Therefore, there exists a need for an electrical connector with an increased sealing ability for a given level of mechanical integrity during insertion and/or extraction of the terminal.

### SUMMARY OF THE INVENTION

The invention relates to an electrical connector according to claim 1.

In other embodiments, one might also use one or more features of claims 2-8.

The present invention is also related to a method of manufacturing a connector according to claim 9.

### BRIEF DESCRIPTION OF THE DRAWINGS

Other advantages and features of the invention will appear during the following description of one of its embodiments, provided as a non-limiting example, on the accompanying drawings:

On the drawings:

FIG. 1 is a sectional view of a connector with an electrical connection member in assembled condition,

FIG. 2 is a front view of a mat sealing joint for the electrical connector of FIG. 1,

FIG. 3 is a perspective view showing an example of an electrical connection member for the electrical connector of FIG. 1,

FIG. 4 is a partial sectional view along line IV-IV of FIG. 2 for a prior art sealing joint,

FIG. 5 is a sectional view along line IV-IV of FIG. 2 for an embodiment of the invention.

On the Figures, the same references designate the same or similar elements.

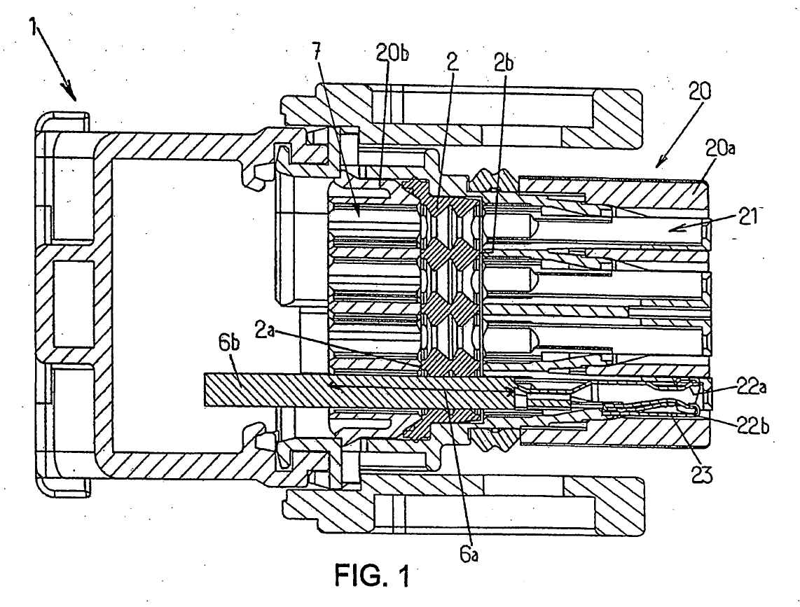

FIG. 1 is a sectional view of an electrical connector 1. This connector comprises a housing 20 made of an electrically insulating material such as glass-fiber reinforced poly-butylene terephthalate (PBT). The housing comprises a front part 20a arranged in columns and rows of passageways 21 for receiving electrical connection members to be described in further details later on. The housing also comprises a back part 20b, or “grid”, comprising passageways corresponding to the passageways 21 of the front part of the housing.

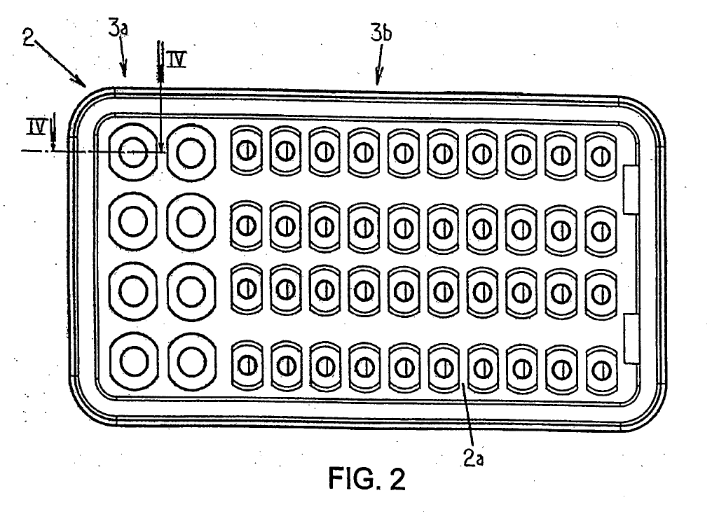

A sealing device such as a mat sealing joint 2 is inserted between the front part 20a and the back part 20b of the housing. The mat sealing joint will be described later in more details with reference to FIGS. 2 and 5.

As shown in the embodiment of FIG. 2, the mat sealing joint 2 is in the shape of a parallelepipedic plate made of a material such as Liquid Silicone Rubber. A suitable example could be a material provided by GE-Bayer under reference Silopren 3596/30 (30 Shores A). The above material also has an auto-lubricating property of 5%, thereby facilitating the terminal insertion.

Other materials such as Heat Curing Rubers (HCR), Silicone or Ethylene Propylene Diene Monomers (EPDM), thermoplastic elastomers (ETP), or others, could also be used for the sealing joint 2.

The sealing joint 2 comprises an insertion face 2a and an opposing extraction face 2b (FIG. 1). In the described example, two series 3a, 3b of passageways are defined in the mat sealing joint, a first series comprising broad passageways 7 for receiving large electrical terminal for insertion into large passageways of the housing, and a second series comprising narrow passageways for receiving small electrical terminal for insertion into small passageways of the housing. The dimensions of the joint, the number of series, and the number, positions and sizes of passageways are related to the passageways of the housing, depending on the application required for the connector. The shape, dimensions, positions and sizes pictured on FIG. 2 are only exemplary and could vary from one mat sealing joint to another.

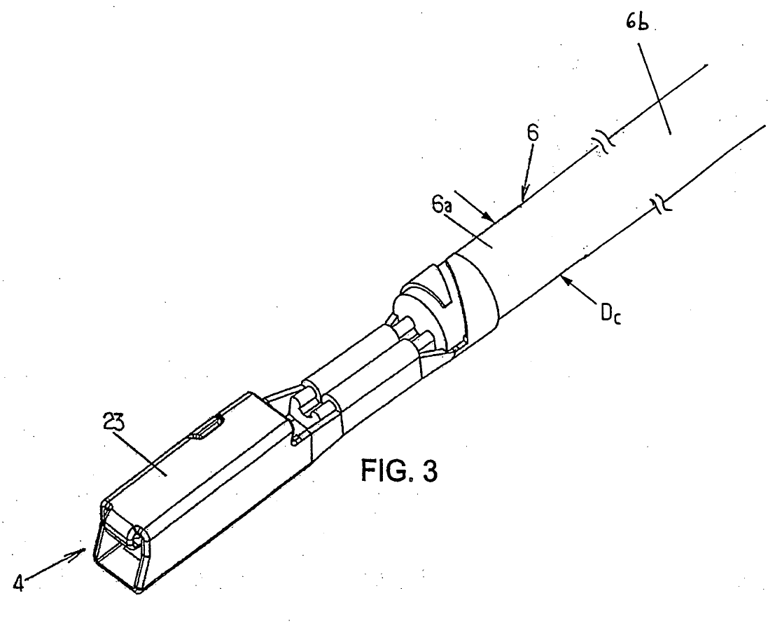

FIG. 3 discloses a female terminal, connected to a cable, adapted to be received into the electrical connector according to the present invention.

The female terminal comprises:

a first portion formed by a cage including two metallic blade members 22a, 22b for mating with a complementary male terminal;

a second portion, extending from the first portion, and comprising crimping arms for crimping onto the cable wire; and

a cable fixing portion extending from said second portion adapted to be, for instance, crimped onto the cable sheath.

Coming back to FIG. 1, an example of an electrical terminal is shown in assembled condition inside the housing in the bottom passageway. The representation of the passageway of the sealing joint in this assembled condition is illustrative only, and is not intended to represent the actual shape of the sealing joint passageway in the assembled condition of the terminal.

In the present example of a female terminal is inserted into the passageway 21 of the front part 20a of the housing, for connection with a mating male terminal.

A cable is connected to the terminals via the exposed wires of the cable, which were surrounded by an insulating sheath 6, so as to form an electrical connection assembly as shown in FIG. 3. Said electrical connection assembly may be divided in 3 mains portions namely:

a terminal portion;

a junction portion 6a, adjacent to the cable fixing portion of a terminal, designed to be accommodated into the passageway of the sealing joint; and

a cable sheath portion 6b designed to extend outside of the housing for connection to another electric equipment. In this example, the junction portion 6a is somehow cylindrical, and exhibits a diameter D_{c}.

In the example embodiment, the terminal has a somehow rectangular section of 2.40 millimeters (mm) times 2.70 mm, leading to a cross-section of about 2.40*2.70=6.48 square millimetres (mm²).

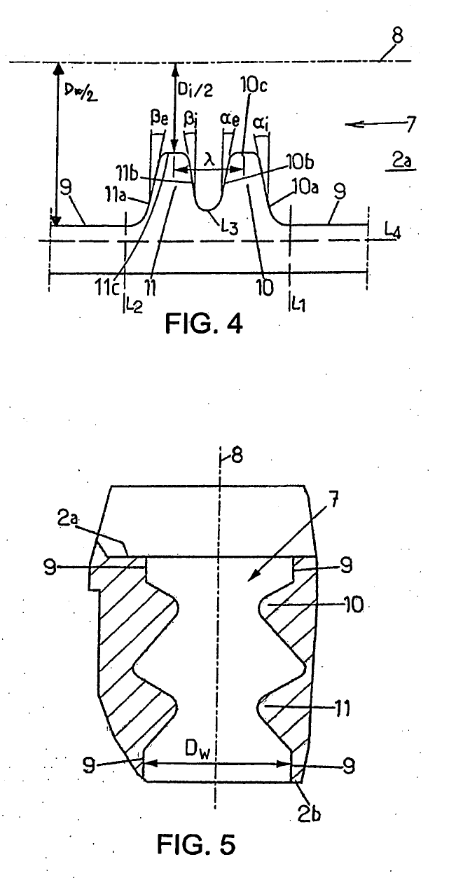

FIG. 4 is a partial sectional view of a part of the sealing joint along the insertion direction, along line IV-IV of FIG. 2. An axisymmetrical passageway 7 extends about a symmetry axis 8 from the insertion face 2a of the sealing joint to the extraction face 2b of the sealing joint. Consequently, the electrical connection assembly is to be inserted from the right side of FIG. 4. The passageway is defined by a wall 9, from which project a first lip 10, which is the closest lip to the insertion face 2a, and thus called “insertion lip”, and at least another, “extraction” lip 11, which is the closest lip to the extraction face. Other lips could be inserted in between. At the beginning of the first lip and at the end of the second lip, the wall has a diameter D_{w}.

A membrane could also be disposed between two adjacent lips, said membrane being torn at insertion of the connection member.

The first lip 10 has an external face 10a facing towards the side of the insertion face 2a, and an opposite internal face 10b. Further, a top face 10c, sensibly of the shape of a flat ring, faces the axis 8. The inner diameter Dᵢ of the passageway is therefore defined as the shortest diameter inside the passageway, orthogonal to the axis 8 at the level of the top face 10c. The top face is for example flat, as pictured, or could be arc-shaped.

In connection with FIG. 4, an insertion angle αᵢ for the first lip is defined as the angle between the external face 10a of the first lip and the axis perpendicular to the symmetry axis 8. An extraction angle αₑ for the first lip is defined as the angle between the internal face 10b of the first lip and the axis perpendicular to the symmetry axis 8.

Similar definitions are provided for the external face 11a of the second lip on the side of the extraction face 2b and the internal face 11b of the second lip opposed thereto, and thus facing the internal face 10b of the first lip. Top face 11c, insertion βᵢ and extraction βₑ angles for the second lip are defined accordingly.

The mid-line of the top face 10c for the first lip and the mid-line of the top face 11c for the second lip are defined, and the shortest distance between these two lines is referred hereafter as a measure of the “inter-lip gap” λ, i.e. the distance between the two lips. In the case of an arc-shaped top face, the mid-lines will be defined as the points where the face 11c is tangent to a parallel to the symmetry axis 8.

The embodiment of FIG. 4, also called “V₀”, which is not part of the invention, does not succeed in the above-mentioned sealing tests for insertion and extraction of the connection elements. The first step for designing a passageway for a given connector is thus to set the wall diameter, for instance the passageway diameter and the terminal cross-section dimension will show a ratio of about 1.1.

This embodiment of FIG. 4 has for other features an insertion angle αᵢ of about 10°, an internal diameter Dᵢ of 1.2 mm and an inter-lip gap of 1.1 mm. The lip height, which corresponds to half the difference between the wall diameter D_{w} and the internal diameter Dᵢ was about 0.9 mm.

Studies were performed to obtain a better compressive force on the cable junction portion 6a inside the sealing joint. To identify the parameters of interest, recourse was made to numerical simulations, and prototyping and testing for the relevant geometries obtained through simulation.

The numerical simulations were performed by a finite-element solver by taking into account the axisymmetric nature of the passageway. This enabled to mesh the joint in 2 dimensions, as well as the contact. The contact is not, strictly speaking axisymmetric, but the idea of the simulation is to understand rules which link the geometry of the sealing joint and the sealing and insertion properties of the sealing joint. This simplification enabled to obtain results for a low calculation cost, which results are confirmed by experiment on prototypes.

The material properties chosen for the sealing joint were those of the above-mentioned GE-Bayer Silopren 3596/30 (30 Shores A). This material was modelled with the following mechanical properties:
Modulus of elasticity at 300% strain: 2.2 Newton per square millimetre (N/mm²),
ultimate strain: 640%,
tear strength: 7.2 N/mm²,
compressive permanent set: 11%.

Although this material was selected as an example for the present study, other materials such as Heat Curing Rubers (HCR), Silicone or Ethylene Propylene Diene Monomers (EPDM) or thermoplastic elastomers (ETP) or others could also be used for a mat sealing joint within the scope of the invention.

The contact being metallic was considered rigid and a constant speed movement was applied to it along the symmetry axis 8. For the study, the following results were of interest:
the component along said symmetry axis of the reaction force applied by the sealing joint on the cable junction portion during insertion, this component being directly linked to the force required for inserting the contact at constant speed (later called “insertion force”),
the component orthogonal to said symmetry axis of said reaction force applied by the sealing joint on the cable junction portion during insertion, this component being indicative of the force applied by the joint on cable sheath after insertion (later called “sealing force”),
the component along said symmetric axis of the reaction force applied by the sealing joint on the contact element during extraction (movement opposite to insertion), this component being directly linked to the force required for extracting the contact at constant speed (later called “extraction force”).

The global maximum value, or local maximum values of these forces during insertion/extraction were considered as the relevant parameters for this study.

Insertion/extraction force is considered to be linked directly to a possibility of rupturing the material of the sealing joint during insertion/extraction. To keep the insertion force under a given threshold is one of the requirements during the testing of the mat sealing joint. A joint with improper level for these characteristics would exhibit a too high risk of rupture, and should be discarded.

The sealing force, or radial force, is directly linked to the average radial stress exerted by the joint on the cable junction portion 6a and is indicative of the sealing ability of the joint.

Another parameter of interest during numerical simulation is the strain to which the material of the sealing joint is submitted, since the strain is directly linked to the possible tearing of the material.

The insertion test for the above-described embodiment showed that, during insertion, the first lip was bent until it came into contact with the second lip. After the two lips had come in contact, further insertion showed an increase of the insertion force up to a maximal value. The insertion force then decreased, showing a local maximum when the contact interacted directly with the second lip. The maximal insertion force obtained was scaled to 1. Results for the further numerical simulations will likely be scaled, to be compared with the indicia “1” defined by V₀. At extraction, similar features to those of insertion were observed.

Sealing force was maximal in a state in which both lips are bent with their faces 10a, 11b in contact with the cable.

A maximum sealing force was recorded. Similarly, this maximum sealing force was also scaled to define an indicia “1” for later numerical results.

For the study, different sealing joint geometries were tested. In these studies, for different examples, the inter-lip gap λ, the internal diameter Dᵢ, and the angles were varied.

It can be observed that maximal insertion force can be reduced by an increase in the inter-lip gap parameter. It was observed that, for a given geometry, increasing the inter-lip gap up to a point at which the first lip will not interfere with the second lip during insertion or extraction will prevent the build-up of the insertion force. Different studies performed by raising the inter-lip gap, based on the original geometry described in relation with FIG. 4, showed that a significant decrease of the insertion force to 0.95 was observed as soon as the inter-lip gap reached 1.5 mm, and more preferably over 1.8 mm.

Surprisingly, the increase on the inter-lip gap from the geometry of FIG. 4 has no detrimental influence on the sealing force. It could even provide an increase in sealing force. The sealing force could reach 1.2 or more, dependant on the inter-lip gap: Increasing the inter-lip gap provides a good sealing force on cable junction portion, for a low insertion force, thus with a decreased risk of tearing the material at insertion.

From other studies, still starting from the geometry of FIG. 4, it was also observed that an increase in sealing force can be achieved by increasing the insertion angle αᵢ for the first lip. The second lip was designed symmetrically to the first lip with respect to a middle plane running in between the two lips. By this symmetrical design, extraction and insertion features are kept similar.

By increasing the insertion angle for the first lip (and thus the extraction angle for the second lip, by way of symmetry), the volume of material of the sealing joint actively contributing to the sealing of the cable increases. This provides an increase in the sealing force. This also provided an increase in the insertion force, yet this later increase was lower than the increase in sealing force. A significant increase in the sealing force was measured for an insertion angle of 20° or more.

To a surprising extent, it was further observed that, when the insertion angle αᵢ for the first lip is further raised, to 30° and more preferably to 45° or more, a further increase in sealing force was observed, which was not due to the sole effect described above. For such an insertion angle αᵢ for the first lip, it was observed that the first lip, and possibly the second lip, after insertion, was positioned with their top face against the cable. The first lip thus works in compression against the cable, and does not exhibit the bending behaviour of the embodiment of FIG. 4. The lips exhibited compression strain. This compressive behaviour provided an important raise in the sealing force.

As a general rule, an insertion angle of between 15° and 50° provided good results, especially for insertion angles of between 20° and 30°.

Other studies were performed in order to study the effect of the internal diameter Dᵢ. Starting from the geometry of FIG. 4, other geometries were tested with increasing diameters, for constant wall diameter D_{w}, thus meaning shorter lips. These studies showed that both the insertion force and the sealing force were decreased when compared to the geometry of FIG. 4. Yet, and surprisingly, the sealing force was decreased less than the insertion force. It is believed that, by increasing the internal diameter, the lips will be less submitted to bending during insertion of the contact. They would behave more in compression than in bending for sealing. As long as the sealing force is sufficient to obtain the necessary compression against the cable, it could thus be of interest to increase the internal diameter.

The studies showed that, when the internal diameter is increased, the inter-lip gap is a less significant, parameter, since, as the lips are shorter, they are less likely to interfere during insertion/extraction.

In order to summarize the above results, an efficient surface of the retention region of the joint, in the cross-section of the joint, was defined as follows:
a top line L₁ was drawn at the intersection of the external face of the insertion lip and the cylindrical wall of the passageway,
a bottom line L₂ was drawn at the intersection of the external face of the extraction lip and the cylindrical wall of the passageway,
a profile line L₃ was drawn defining the profile of the retention portion of the passageway, and
an arbitrary back line L₄ was drawn defined at an arbitrary distance from the symmetry axis within the material of the sealing joint, this arbitrary distance being kept fixed among the different embodiments.

For example, this arbitrary distance might be determined as half the distance between two symmetry axis of two neighbouring passageways of the sealing joint.

The efficient surface is representative of the part of the sealing joint which is active both during insertion, extraction of the terminal and for sealing around the cable. The area of this surface, also called “transverse area of the sealing portion”, is directly linked to the volume of the part of the sealing joint which is active both during insertion, extraction of the terminal and for sealing the cable junction portion inside the sealing joint.

It was shown that an increase of the area of this surface was directly linked to an increase in the sealing force applied on the cable junction portion. Such an increase can be performed by raising the inter-lip gap, by raising the insertion angle for the first lip, the extraction angle for the second lip, and/or by raising the height of each lip.

The corresponding transverse area of the cable junction portion, defined between lines L₁, L₂, the central axis 8 and the external wall of the cable was also estimated for each embodiment. The transverse area for the cable is thus equal to (D_{c}/2)*d(L₁;L₂), where d(L₁;L₂) is the distance between L₁ and L₂. A ratio of the transverse area of the cable to the transverse area of the sealing portion was calculated. For instance, in the case of embodiment V₀ and for a cable having a diameter of 1.9 mm, this transverse area ratio was equal to 0.94, good results in sealing force were obtained for embodiments showing transverse area ratio of not higher than 0.76. Thus, the lower the transverse ratio, the better the sealing force.

Combination of these features with features which reduce the insertion force, or which cause an increase in the insertion force which is less than the increase in sealing force, are of interest within the scope of the invention.

It should be noted that, although the area of the mentioned surface was taken here as an indicator, the corresponding material volume over the periphery of the sealing joint could be another parameter of interest. This volume could be defined by:
a top plane P₁ comprising line L₁, orthogonal to the symmetry axis,
a bottom plane P₂ comprising line L₂, orthogonal to the symmetry axis,
a profile surface P₃ defining the profile of the retention portion of the passageway over its periphery, and
an arbitrary back cylinder P₄ defined at an arbitrary distance from the symmetry axis within the material of the sealing joint, this arbitrary distance being kept fixed among the different embodiments.

Conducted experiments are summarized in the below table.

TABLE
Simulation results

| | Version number | | | | |
|---|---|---|---|---|---|
| | V0 | | | | |
| | (prior art) | V1 | V2 | V3 | V4 |
| Insertion angle for the | 10° | 20° | 20° | 45° | 45° |
| first lip | | | | | |
| Extraction angle for the | 10° | 10° | 10° | 10° | 10° |
| first lip | | | | | |
| Insertion angle for the | 10° | 10° | 10° | 10° | 10° |
| second lip | | | | | |
| Extraction angle for the | 10° | 20° | 20° | 45° | 45° |
| second lip | | | | | |
| Internal diameter (mm) | 1.2 | 1.2 | 1.5 | 1.2 | 1.2 |
| Inter-lip gap (mm) | 1.1 | 2 | 1.1 | 1.1 | 1.6 |
| Section area (mm²) | 4.99 | 5.43 | 4.92 | 5.98 | 6.1 |
| Sealing force (compared to | 1 | 1.27 | 0.91 | 1.45 | 1.52 |
| Sealing force for V₀) | | | | | |
| Insertion force (compared | 1 | 0.93 | 0.72 | 1.28 | 1.32 |
| to insertion force for V₀) | | | | | |

The above considerations led to provide an improved sealing joint with the following parameters: all angles equal to 30°, an internal diameter of 1.2 mm and inter-lip gap of 2.5 mm. The section area measured for this embodiment by the above method was 5.93 mm². The retention force was 1.52 and the insertion force 1.01.

The extraction tests showed that, even with a large extraction angle for the second lip, tearing problems may occur at the first lip if its internal face is too steep, in particular when the terminal is more aggressive during extraction than during insertion.

Another possible embodiment is provided in detail on FIG. 5. In this example, the wall diameter was again set to 3 mm, the insertion angle for both lips are set to 30°, while the extraction angles for both lips are set to 50°. The inter-lip gap was set to 2.15 mm and the internal diameter was set to 1.65 mm.

In both simulation and experiment, this sealing joint provided a good compromise ensuring superior sealing performance, while the insertion force was kept low. Good sealing properties are thus expected, as well as high reliability since the likeliness of damage at insertion/extraction is kept low.

Thus, the extraction angle could be chosen slightly over the insertion angle, in particular when the features of the terminal are more aggressive at extraction than at insertion. Extraction angles of 20°-70° were deemed of interest, in particular those between 30° and 50°.

This profile was obtained by the following method:
knowing the geometrical characteristics of the contact and the sheath, and the material characteristics of the sealing joint, determining the wall diameter and the internal diameter for the passageway,
based on the mechanical properties of the sealing joint, determining the insertion angle for the first lip,
determining the extraction angle for the first lip,
in view of the application, and of the shape of the terminal, determining whether the second lip should be designed as a symmetric to the first lip, to obtain extraction features similar to the insertion features,
determining the inter-lip gap.

Depending of the applications, one or more of these steps could of course be omitted, or these steps could be performed in a different order.

The invention is not intended to be defined only by the embodiment of FIG. 5, but by the scope of the claims.

1. An electrical connector comprising: a sealing joint having an insertion face and an extraction face opposite said insertion face, and at least one passageway extending therebetween, said passageway being for receiving an electrical connection assembly extending therethrough in an assembled condition of the electrical connector, said electrical connection assembly comprising a terminal protruding from said extraction face of the sealing joint, and a cable connected thereto, said cable comprising a junction portion designed to be accommodated inside said passageway, and having a diameter D_{c}, said passageway having a wall of wall diameter D_{w} about a passageway central axis, and a retention region comprising a first lip protruding from said wall, a second lip protruding from said wall, and an inter-lip gap between said lips, said first lip being closer from the insertion face than said second lip, each of said lip comprising, in a non-assembled state of the electrical connection assembly, an internal face facing towards the internal face of a corresponding lip, an external face opposite said internal face and a top face between said internal and external faces, said top face facing said central axis, and having an internal diameter Dᵢ.

2. Electrical connector according to claim 1 wherein the ratio of Dᵢ to D_{w} is comprised between 0.5 and 0.8.

3. Electrical connector according to claim 1 wherein an insertion angle for said first lip, defined between said external face of said first lip and an axis perpendicular to the symmetry axis 8, is comprised between 15° and 50°, and preferably between 20° and 30°.

4. Electrical connector according to claim 1 wherein an extraction angle for said second lip, defined between said external face of said second lip and an axis perpendicular to the symmetry axis, is comprised between 20° and 70°, and preferably between 30° and 50°.

5. Electrical connector according to claim 1 wherein a transverse area of the section of the passageway is defined between a top line and a parallel bottom line, a profile line and a back line, said top line passing at an intersection between said wall and said external face of said first lip, said bottom line passing at an intersection between said wall and said external face of said second lip in said section, said profile line defining the wall of the retention portion of the passageway, and said back line being drawn parallel to said symmetry axis, at half a distance between the symmetry axis of two neighbouring passageways of the sealing joint.

6. Electrical connector according to claim 5 wherein a transverse area of the cable is defined between the top line, the bottom line, the central axis, and the external face of the cable, and wherein a ratio of said transverse area of the cable to said transverse area of the passageway is less than 0.76.

7. Electrical connector according to claim 1, wherein, in the assembled condition of the electrical connection assembly, at least one lip, and preferably all lips mostly feature compression strain.

8. Electrical connector according to claim 1, wherein the contact has a largest transverse dimension of less than 4 mm, wherein the sealing joint is made of liquid silicon rubber, wherein said insertion angle for each lip is about 30°, wherein said extraction angle for each lip is about 50°, wherein said internal diameter is about 1.65 mm, wherein said wall diameter is about 3 mm, wherein the inter-lip gap is about 2.15 mm.

9. A method of manufacturing an electrical connector comprising: manufacturing a sealing joint having an insertion face and an extraction face opposite said insertion face, and at least one passageway extending therebetween, said passageway being for receiving an electrical connection member extending therethrough in an assembled condition of the electrical connector, said electrical connection assembly comprising a terminal and a cable connected thereto, said cable comprising a junction portion designed to be accommodated inside said passageway, and having a diameter D_{c}, manufacturing said passageway to have a symmetric wall of wall diameter D_{w} about a passageway central axis, and a retention region comprising a first lip protruding from said wall, a second lip protruding from said wall, and an inter-lip gap between said lips, said first lip being closer from the insertion face than said second lip, manufacturing each of said lip to comprise, in a non-assembled state of the electrical connection assembly, an internal face facing towards the internal face of a corresponding lip, an external face opposite said internal face and a top face between said internal and external faces, said top face facing said central axis, and having an internal diameter Dᵢ.
